(19) United States
(12) Patent Application Publication
(10) Pub. No.: US 2005/0072085 A1
(43) Pub. Date: Apr. 7, 2005

(54) Composite french door

(76) Inventor: Jean Goudreau, Lachenaie (CA)

Correspondence Address: Goudreau Gage Dubuc;Stock Exchange Tower, Suite 3400, 800 Place Victoria, P.O. Box 242, Montreal, QC, H4Z 1E9, CA

(21) Appl. No.: 10/764,564

(22) Filed: Jan. 27, 2004

(30) Foreign Application Priority Data
Jan. 29, 2003 (CA) 2,417,611

(51) Int. Cl. E06B 3/70; E04C 2/54

(52) U.S. Cl. 52/455; 52/456; 52/784.1

(57) ABSTRACT

A composite French door provided with assembled stiles and top and bottom transverse pieces is described herein. The stiles and transverse pieces include outer faces that are pre-finished and provided with beveiled edges so that once assembled, a V-shaped notch is provided at the junction of the various pieces.

### FIELD OF THE INVENTION

The present invention relates to French doors. More specifically, the present invention is concerned with a French door which production is achievable at a reduced cost, while providing pleasing aesthetics.

### BACKGROUND OF THE INVENTION

French doors are well known and are used extensively in high priced houses.

These doors are generally expensive to manufacture since they are made of solid woods that must be carefully sanded and finished after assembly to yield a high-quality end product. Indeed, should the pieces be sanded and finished prior to the assembly of the door, even small variations in thickness are very noticeable to the naked human eye at the junction of the various pieces making the door.

Therefore there is a need in the art for a French door which production is achievable at a reduced cost, while providing pleasing aesthetics.

### SUMMARY OF THE INVENTION

More specifically, in accordance with the present invention, there is provided a composite French door comprising a first and a second door stiles; a top transversal piece mounted between the first and the second door sties; and a bottom transversal piece mounted between the first and the second door stiles; wherein the first and second door stiles and the top and bottom transversal pieces include ping parts.

There is further provided a method for fabricating a composite door comprising the steps of cutting face pieces; cutting edge pieces; cutting spacers; assembling a first and a second face pieces to at least one edge piece into a blank door stile; assembling at least one spacer between two face pieces into a blank transverse piece; cutting a blank door stile into a door stile having a first joining part; cutting a blank transverse piece into a number of transverse pieces each having a second joining part; and assembling a first door stile and a second door stile to a first transverse piece and to a second transverse piece by mating the first joining parts to the second joining parts respectively.

It is to be understood that the term “composite” is to be construed as meaning any assembly of materials different from solid wood.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a front view of a French door according to an embodiment of the present invention;

FIGS. 2A to 2E illustrate an assembly of a door stile used in the door of FIG. 1;

FIGS. 3A to 3C illustrate an assembly of a number of door bottom transverse pieces used in the door of FIG. 1;

FIGS. 3A to 3C illustrate the assembly and the cutting of a number of blank bottom transverse pieces used in the door of FIG. 1;

FIGS. 4A to 4C illustrate the assembly and the cutting of a number of top transverse pieces used in the door of FIG. 1;

FIGS. 5A and 5B illustrate a junction between a stile and a transversal piece in the door of FIG. 1, according to an embodiment of the present invention;

FIGS. 6A and 6B illustrate a junction between a stile and a transversal piece in the door of FIG. 1, according to a further embodiment of the present invention; and

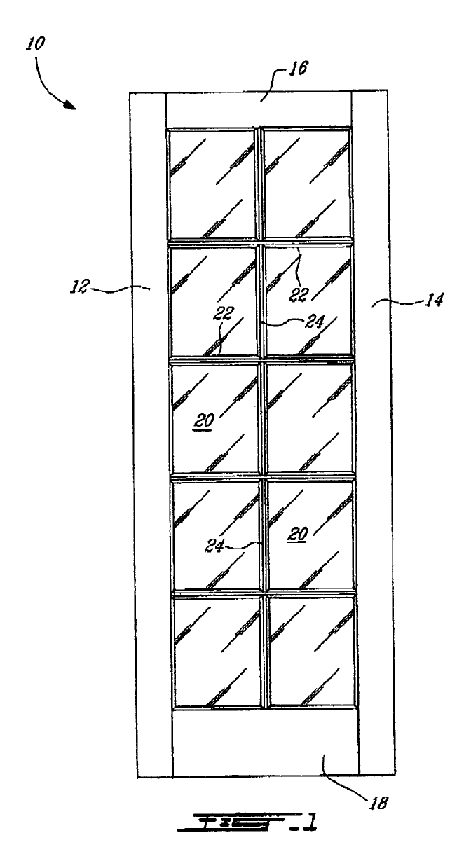

7 is a perspective view, partly in section, of a portion of the door of FIG. 1.

### DESCRIPTION OF EMBODIMENTS OF THE INVENTION

There is provided a French door made of generally hollow stiles and top and bottom transverse pieces, all having pre-finished faces, which yields reduced finishing costs and reduced material costs. Pieces of solid wood are used at junctions between pieces of the door to allow for a conventional assembly of these pieces and to yield a conventional looking finished product.

Turning first to FIG. 1 of the appended drawings, a French door according to an embodiment of the present invention will be generally described.

The door 10 comprises first and second door stiles 12 and 14, a top transverse piece 16 mounted between the stiles 12 and 14 and a bottom transverse piece 18 mounted between the stiles 12 and 14. The door 10 may comprises a number of glass panels 20 mounted between horizontal 22 and vertical 24 cross pieces.

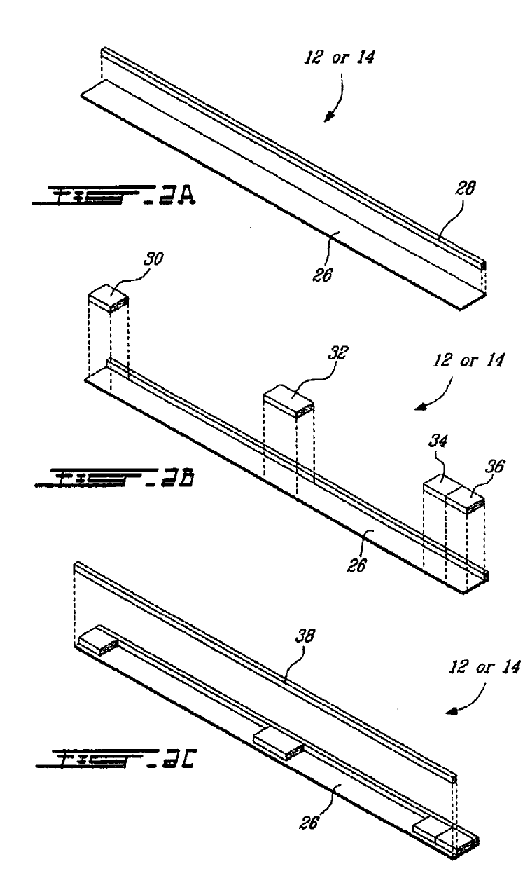

Turning now to FIG. 2A to 2E, the construction of a blank door stile (12 or 14) will be described.

In FIG. 2A a first face piece 26 is provided and assembled with a first solid wood edge piece 28, via a wood adhesive for example.

A number of solid wood spacers 30-36 are adhered to an inside surface of the first face piece 26 (FIG. 2B).

A second solid wood edge piece 38 may then be adhered to the first face piece 26 (FIG. 2C).

In FIG. 2D, a second face piece 40 is adhered to edge pieces 28 and 38 and to spacers 30-36 to yield a blank door stile (FIG. 2E).

It is to be noted that the first edge piece 28, the second edge piece 38 and the number of spacers 30-35 may be provided as a unit and mounted adhesively in a sandwich-like manner between the first face piece 26 and the second face piece 40, for example.

The face pieces 26 and 40 may be made of solid wood or may be a made of a laminate or any composite material. Similarly, the spacers may be made of solid wood or may be a made of a laminate or any composite material for example.

A number and position of the spacers depend may vary depending on the type of desired door. Optionally, foam material may be provided between the spacers.

The resulting blank door stile is light-weighted.

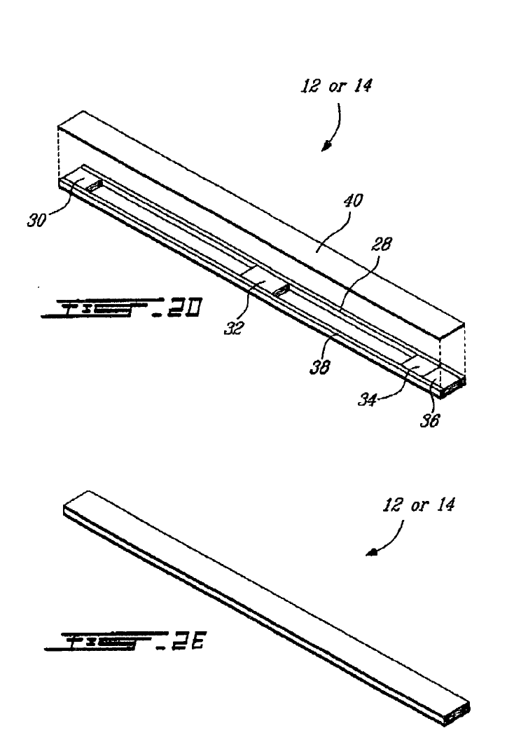

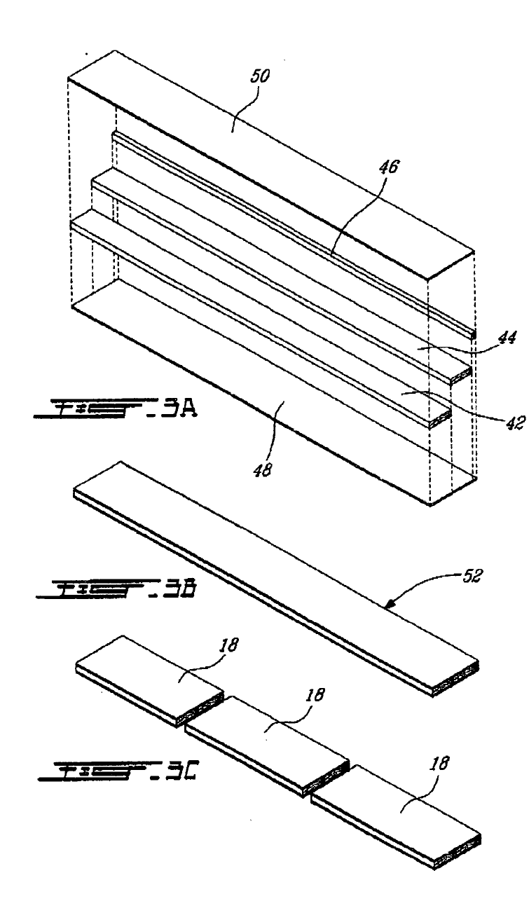

FIG. 3A to 3C illustrate the assembly and the cutting of a number of blank bottom transverse pieces 18.

In FIG. 3A, spacers 42 and 44 and an edge piece 46 are adhered to and between two face pieces 48 and 50 to yield a full-length board 52. The full-length board 62 (see FIG. 3B) may then be cut into a number of blank bottom transverse pieces 18 (see FIG. 3C).

It is to be noted that the spacers 42 and 44 and the edge piece 46 may be provided as a unit and mounted adhesively in a sandwich-like manner between the two face pieces 48 and 50, for example.

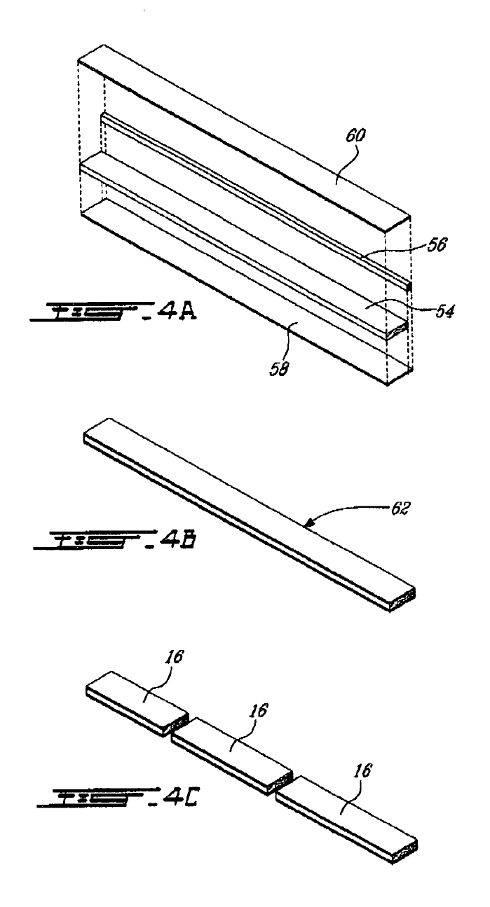

FIG. 4A to 4C illustrate the assembly and the cutting of a number of blank top transverse pieces 16.

In FIG. 4A, a spacer 54 and an edge piece 56 are adhered to and between two face pieces 58 and 60, to yield a full-length board 62. The full-length board 62 (see FIG. 4B) may then be cut into a number of blank top transverse pieces 16 (see FIG. 4C).

It is to be noted that the spacer 54 and the edge piece 56 may be provided as a unit and mounted adhesively in a sandwich-like manner between the two face pieces 58 and 60, for example.

Once the blanks of the different elements of the door are made as described hereinabove, each blank is cut so as to yield a corresponding finished element.

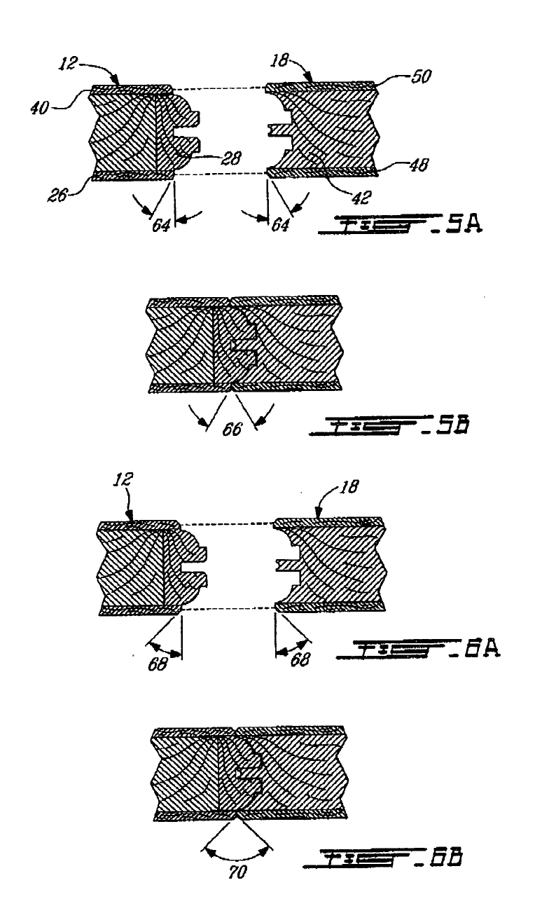

For example, a blank door stile is cut so as to shape the edge piece 28 into a joining edge 28 as illustrated in FIG. 5A, and so as to bevel the faces 26 and 40 thereof, thereby yielding a finished door stile 12 as a unitary piece having a joining part. A blank bottom transverse piece is cut so as to shape the spacer 42 thereof into a joining spacer 42 illustrated in FIG. 5A having a shape mating the shape of the joining edge 28, and so as to bevel the faces 48 and 50, thereby yielding a finished bottom transverse piece 18 as a unitary place having a joining part

FIGS. 5A and 5B illustrate a junction between such a finished door stile 12 and a finished transversal piece 18.

As may be seen from these Figures, the faces 26 and 40 of the finished door stile 12, as well as the faces 48 and 50 of the finished transversal piece 18 are beveiled (see angles 64) and create a V-shape notch. In this example, the beveiled pieces create a sixty degree angle 66 (see FIG. 5B). Such an angle allows for a slight misalignment of outer surfaces of the faces 26, 40, 48 and 50. Indeed, it has been found that the eye is fooled by this V-shape notch between adjacent surfaces.

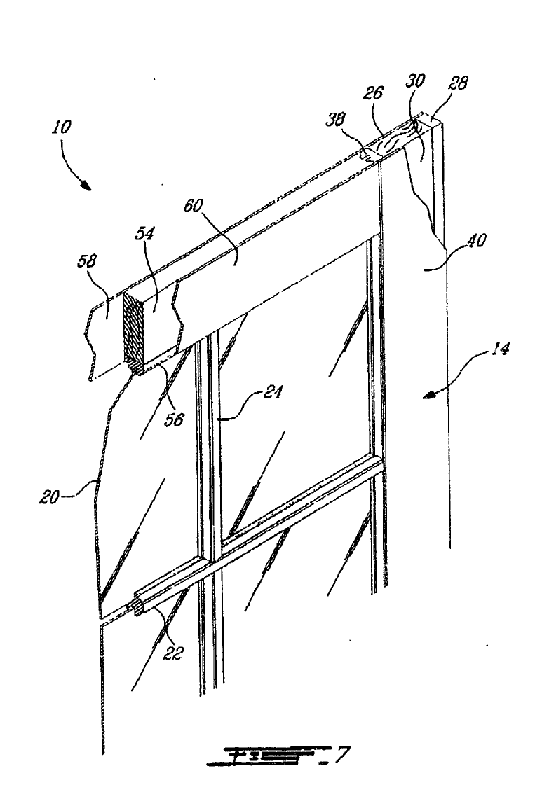

In FIGS. 6A and 6B, the faces of the finished door stile and the faces of the finished transversal piece are so beveiled (angles 68) so that a ninety (90) degree angle (see angle 70 in FIG. 68) is formed when these pieces are assembled, via an adhesive for example.

FIG. 7 illustrates, in a partly sectional view, the assembly of the various finished pieces described hereinabove into a French door according to the present invention.

As will be understood by one skilled in the art, even though the French door 10 illustrated in the appended drawings is provided with a number of glass panels 20, other style of French doors, with or without glass panels, may be fabricated according to the present invention.

Although the present invention has been described hereinabove by way of embodiments thereof, it may be modified, without departing from the nature and teachings of the subject invention as defined in the appended claims.

1. A composite French door comprising:
a first and a second door stiles;
a top transversal piece mounted between said first and said second door stiles; and
a bottom transversal piece mounted between said first and said second door stiles;
wherein said first and second door stiles and said top and bottom transversal pieces include joining parts.

2. The composite French door according ta claim 1, wherein said first and second door stiles each comprise a first and a second face pieces separated by outer edge pieces to form a first unitary piece having a first joining part, and wherein said bottom transverse and said top transverse pieces each comprises a spacer adhered to between two face pieces, forming each a second unitary piece having a second joining part.

3. The composite French door according to claim 2, wherein said first and said second door stiles further comprise at least one spacer between said first face piece and said second face piece.

4. The composite French door according to claim 2, wherein said joining parts of the first and second door stiles comprise a V-shape notch in the first and second face pieces thereof and a shape of one of the outer edges thereof in a form of a joining edge, and wherein said joining parts of said bottom transverse and said top transverse pieces comprise a V-shape notch in the first and second face pieces thereof and a shape of the spacers thereof in a form of joining spacers having a shape matting the shape of said joining edges of said joining parts of the first and second door stiles.

5. The composite French door according to claim 4, wherein said first joining parts of the first and second door stiles are made by beveiling said first face piece and said second face piece.

6. The composite French door according to claim 2, wherein said first face piece and said second face piece are made in one of a solid wood and a composite material.

7. The composite French door according to claim 2, wherein said outer edge pieces are made of solid wood.

8. The composite French door according to claim 2, wherein said first and said second door stiles comprise foam between said first face piece and said second face piece.

9. A method for fabricating a composite door comprising the steps of:
cutting face pieces;
cutting edge pieces;
cutting spacers;
assembling a first and a second face pieces to at least one edge piece into a blank door stile;
assembling at least one spacer between two face pieces into a blank transverse piece;
cutting a blank door stile into a door stile having a first joining part;
cutting a blank transverse piece into a number of transverse pieces each having a second joining part; and
assembling a first door stile and a second door stile to a first transverse piece and to a second transverse piece by mating the first joining parts to the second joining parts respectively.

10. The method according to claim 9, wherein said step of cutting a blank door stile into a door stile having a first joining part comprises cutting the first and the second face pieces thereof with a V-shape notch and shaping one of the at least one edge piece thereof into a joining edge; and wherein said cutting a blank transverse piece into a number of transverse pieces each having a second joining part comprises cutting the first and the second face pieces thereof with a V-shape notch and shaping the at least one spacer thereof into a joining spacer having a shape matting a shape of the joining edge.

11. The method according to claim 9, wherein said step of cutting face pieces comprises cutting face pieces made in one of a solid wood and a composite material.

12. The method according to claim 9, wherein said step of cutting edge pieces comprises cutting edge pieces made of solid wood.

13. The method according to claim 9, wherein said step of assembling a first and a second face pieces to at least one edge piece into a blank door stile comprises providing foam between the first and the second face pieces.
